(19) United States
(12) Patent Application Publication
(10) Pub. No.: US 2018/0073840 A1
(43) Pub. Date: Mar. 15, 2018

(54) Scope Mount

(71) Applicant: Eric J. Kristoffersen, Ridgefield, CT (US)

(72) Inventor: Eric J. Kristoffersen, Ridgefield, CT (US)

(21) Appl. No.: 15/704,042

(22) Filed: Sep. 14, 2017

Related U.S. Application Data
(60) Provisional application No. 62/394,308, filed on Sep. 14, 2016.

(51) Int. Cl. F41G 11/00; F41G 1/16; F41G 1/38; G02B 5/12

(52) U.S. Cl. CPC F41G 11/003; G02B 5/12; F41G 1/38; F41G 1/16

(57) ABSTRACT

Sight mounts for firearms (and/or other ranged devices) having features that provide for (i) a dual-sight mount, (ii) a low-profile sight mount, and/or (iii) a sight mount with improved mounting characteristics.

### CROSS-REFERENCE TO RELATED APPLICATIONS

The present application is a Non-provisional of, and claims benefit and priority under 35 U.S.C. §119(e) to, U.S. Provisional Patent Application 62/394308 filed Sep. 14, 2016 and titled “SCOPE MOUNT”, the entirety of which is hereby incorporated by reference herein.

### BACKGROUND

Firearms and other ranged-devices are capable of being oriented or “sighted in” utilizing various sighting mechanisms. Some of the most common are fixed or “iron sights” such as U-notch and post, U-notch and bead, V-notch and post (or “dovetail”), V-notch and bead, Partridge, Express, and trapezoid open sights, as well as various aperture or “peep” sights such as “ghost ring” and diopter sights. Optics are also often utilized for firearm and ranged-device sighting, including telescopic sights, reflective or “reflex” sights, and laser sights. While the fixed or “iron” sights are typically coupled to a firearm (or other device) at the time of manufacture, e.g., along the top surface with a rear sight portion on the receiver and a front sight portion typically near the end of the barrel, optical sights or sighting devices are typically mounted or coupled to the firearm by the end-user. As such, there are a small number of accepted or standardized methods of mounting after-market sighting devices (or other accessories) to a firearm or ranged device.

The two most common sight mounting methods utilize either a “Weaver” style rail base (named for the inventor Mr. William Ralph Weaver of the W. R. Weaver Company of Newport, Ky.) or a “Picatinny” rail base (named for the Picatinny Arsenal in Morris County, N.J. that developed the associated MIL-STD-1913 standards specification published on Feb. 3, 1995), each of which is mounted to the firearm (or other device) and each of which is operable to receive compatible sight mounting fasteners. In many cases, for example, a Picatinny or Weaver-style rail base will be mounted to the upper receiver of a firearm with compatible scope rings coupled thereto. The scope rings retain or couple to a desired optical sight or scope such as a telescopic sight available from many manufactures. In some cases, a reflex sight may be mounted via an adapter to the appropriately-secured Picatinny or Weaver rail base. In the case of certain firearms that have upper ejection ports and/or stripper-clip passages, such as the M14 or M1A rifle variants, the Picatinny rail base or Weaver rail base may be mounted above the receiver by being affixed to a special-purpose “L”-shaped sight mount that couples to the side of the receiver an provides a platform for rail mounting above the receiver.

These methods either don't allow use of the iron sights (e.g., the after-market-mounted optical sights replace or block the original iron sights) or, in cases where the optical sight mounting is raised above the iron sights to allow for their continued utilization, are positioned to high to permit a “cheek weld” or proper “chin weld” for aiming.

These and other attempts at providing firearm sighting systems, while offering certain advantages, suffer from these and other various deficiencies.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a partial front-left perspective view of a firearm sighting system according to some embodiments;

FIG. 2A, FIG. 2B, FIG. 2C, FIG. 2D, FIG. 2E, and FIG. 2F are front, top, left-side, rear, bottom, and right-side views of a sight mount according to some embodiments; and

FIG. 3 is front-right perspective view of a firearm sighting system according to some embodiments.

### DETAILED DESCRIPTION

### I. Introduction

Embodiments presented herein are descriptive of sight mounts for firearms (and/or other ranged devices) such as (i) a dual-sight mount, (ii) a low-profile sight mount, and/or (iii) a sight mount with improved mounting characteristics. Many shooters, for example, find it advantageous to utilize multiple sighting device attached to a particular firearm. Utilizing the well-known Weaver or Picatinny rail mounting systems however, limits the sight mounting options available to the shooter, prevents iron sight utilization (in some cases the rear sight portion or “rear sight” may need to be removed to allow for the mounting of the rail base and/or sight mounted thereto), requires radial reorientation of the firearm to permit a sight picture through a secondary sight, and/or fails to allow for proper sight height which accordingly causes poor cheek and/or chin weld during sighting and/or provides a high-profile sight array that increases carry, packing, and/or transport difficulty. In the case of the popular M14/M1A rifle-style, for example, there are two acceptable methods of mounting optical and/or secondary sights (e.g., in addition to the iron sights).

First, an optical and/or secondary sight may be mounted via a rail base on the barrel. Adding rail base and optical/secondary sight weight to the barrel of the M14/M1A blocks the sight path of the iron sights and increases weight balance instability in an already heavy rifle, which increases both carry and aiming difficulties. In the case that multiple optical/secondary sights are mounted, such as in the case that each of a telescopic sight and a reflex sight are employed, the rail base mounting via the barrel requires the shooter to tilt (i.e., radially reorient) the firearm to switch between the two mounted sights, which is time consuming, increases target acquisition difficulty, and results in a poor shooting stance.

Second, an optical and/or secondary sight may be mounted via a rail base on (or over) the receiver. This method, however, while alleviating the weight distribution issues of barrel-mounted optics, also either blocks (or replaces) the iron sights and/or causes improperly high sight placement that results in poor cheek/chin weld and accordingly a less desirable shooting stance. Sight mounts that attach to the side of the receiver (e.g., on an M14/M1A rifle variant) are also prone to poor seating and/or misalignment. Such sight mounts, for example, in addition to threaded couplings, employ projections or lugs that are designed to mate with corresponding grooves on the side of the receiver. The manufacturing tolerances and variations of these lugs and grooves often result in improper alignment of the sight mount with the side surface of the receiver, however, resulting in a poor fit and/or decreasing the likelihood of a repeatable “zero” orientation in the case that the sight mount is removed and then reinstalled (e.g., in such a case the rifle will likely need to be re-zeroed from scratch).

Embodiments for (i) dual-sight mounts, (ii) low-profile sight mounts, and/or (iii) sight mounts with improved mounting characteristics presented herein solve these and other deficiencies of previous sight mount designs. Embodiments herein provide for multi-sight mounts that, for example, allow for multiple optical and/or other secondary sights to be mounted to a firearm (and/or other ranged device) with a lower profile than previous mounts and that provide for enhanced or improved mounting characteristics. Instead of providing lugs on a receiver-side sight mount that align with the grooves on the receiver side surface (e.g., on an M14/M1A rifle variant), for example, some embodiments employ corresponding grooves and one or more joining objects such as epoxy and/or metal rods or strips to fill and mate the corresponding grooves. According to some embodiments, sight rail bases may be affixed to the sight mount horizontally (or in parallel to a plane of the top of the upper receiver of the firearm) as opposed to the typical vertical (or perpendicular to the plane of the top of the upper receiver of the firearm) orientation, which allows for multiple secondary sights to be mounted and utilized without the need for radial repositioning (i.e., tilting) of the rifle during aiming. These and other attendant advantages are readily perceived in light of the detailed description of the embodiments presented herein.

### II. Sight Mounts

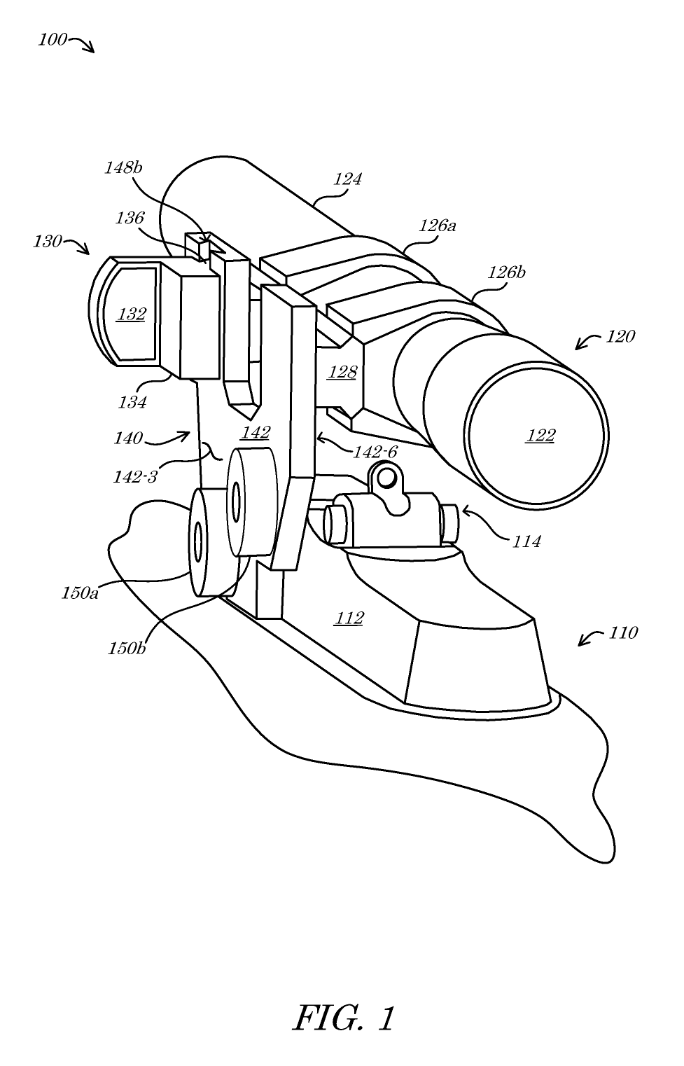

Turning initially to FIG. 1, a partial front-left perspective view of a firearm (and/or other ranged device) sighting system 100 according to some embodiments is shown. The firearm sighting system 100 may comprise, for example, a firearm 110 (and/or other ranged device such as an air rifle, crossbow, pellet gun, paintball gun, etc.) such as the exemplary M14 or M1A rifle partially depicted in FIG. 1. According to some embodiments, the firearm 110 may comprise a receiver 112 (or upper receiver or portion thereof, as depicted) and/or a rear sight 114 (e.g., an “iron” or fixed sight). In some embodiments, the firearm sighting system 100 may comprise a first sighting device 120 such as a telescopic sight or scope. The first sighting device 120 may comprise, for example, optics 122 housed within and/or by a scope body 124 that is retained by or coupled to one or more scope rings 126a-b. The scope rings 126a-b may, in some embodiments, be coupled to a sight or scope rail 128 such as a Weaver rail base or a Picatinny rail base, each of which are common and well known. According to some embodiments, the firearm 110 may comprise a second sighting device 130 such as a reflector or “reflex” sight. The second sighting device 130 may comprise, for example, optics 132 housed within and/or by a scope body 134. In some embodiments, the second sighting device 130 may comprise a mounting element such as a dovetail lug or mount 136, as depicted.

According to some embodiments, the first sighting device 120 and/or the second sighting device 130 may be coupled and/or mounted to the firearm 110 via a sight mount 140. The sight mount 140 may comprise, for example, a sight mount body 142 having a left-side surface 142-3 and a right-side surface 142-6. In some embodiments, the scope rail 128 of the first sighting device 120 may be mounted and/or coupled to the right-side surface 142-6 (e.g., via one or more screws and/or other fasteners not shown in FIG. 1) and/or the dovetail mount 136 of the second sighting device 130 may be mounted and/or coupled to the left-side surface 142-3, e.g., via a mating of the dovetail mount 136 with a dovetail channel 148b disposed and/or formed on the left-side surface 142-3. According to some embodiments, the sight mount 140 may be mounted and/or coupled to the receiver 112 of the firearm 110. As depicted, for example, the sight mount 140 may comprise one or more thumb screws 150a-b (and/or other fasteners) disposed through the left-side surface 142-3 and mating and/or engaging with a left-side of the receiver 112 (such mating not visible in FIG. 1). In such a manner, for example, multiple sights 120, 130 may be affixed to the firearm 110 while retaining usability of (e.g., access to) the iron sights, as exemplified by the rear sight 114 maintaining a clear path of vision underneath the first sighting device 120. In some embodiments, this may be accomplished while affording a lower profile than with previous receiver-side mounts (not shown). Receiver-side sight mounts that are “L”-shaped and provide a platform above the rear sight 114 upon which the scope rail 128 and scope rings 126a-b may be mounted, for example, cause the first sighting device 120 to be positioned higher than the first sighting device 120 as-mounted in FIG. 1. In the firearm sighting system 100 depicted in FIG. 1, for example, the first sighting device 120 may be positioned directly above the rear sight 114, e.g., centered at a distance (e.g., a vertical distance) above the rear sight 114 that is approximately equivalent to the largest diameter of the optics 122 and/or the scope body 124. With previous receiver-side mounts the minimum distance above the rear site 114 that the first sighting device 120 may be installed is approximately equivalent to the largest diameter of the optics 122 and/or the scope body 124 plus the thickness of the over-receiver platform (e.g., the leg of the “L”-shape), plus the height/thickness of the scope rail 128, plus any height or thickness due to the rail-side of the scope rings 126a-b.

Nor do previous sight mounting systems permit each of the first sighting device 120 and the second sighting device 130 to be mounted to the same firearm while maintain usability of the rear sight 114. In some embodiments, the first sighting device 120 and the second sighting device 130 may be coupled such that the optics 122, 132 thereof are centered at the same elevation above the receiver 112 (e.g., in the same horizontal and/or top-of-receiver plane) such that a shooter may readily switch between the two sights 120, 130 simply be alternating which eye is utilized for aiming. In such a manner, for example, a shooter may quickly and easily utilize their left eye (not shown) to obtain a target (also not shown) through the optics 132 of the second sighting device 130 and then switch to their right eye (not shown) to acquire the target through the optics 122 of the first sighting device 120, without needing to reposition or even break a given cheek/chin weld during aiming.

According to some embodiments, the scope rail 128 of the first sighting device 120 may be integrated with the sight mount 140 and/or the sight mount body 142 thereof. The scope rail 128 may be formed on the right-side surface 142-6 of the sight mount body 142, for example, thus decreasing the number of separate parts of the firearm sighting system 100, decreasing manufacturing costs and decreasing the number of points of failure due to firing forces exerted by the firearm 110. In some embodiments, only a single thumb screws 150a-b and/or other fastener such as knobs, screws, cams, clasps, etc. may be utilized in the firearm sighting system 100. While a first one of the thumb screws 150a may engage with a first threaded hole (not shown) in the side of the receiver 112, for example, a second thumb screw 150b that engages with, e.g., a second threaded hole (not shown) of a stripper clip guide (not shown) mounted to the receiver 112, may be utilized or may be optional. According to some embodiments, utilization of the first thumb screw 150a combined with glass-bedding mating of grooves on the right-side surface 142-6 of the sight mount body 142 (not shown in FIG. 1) with grooves on the side of the receiver 112 (not shown) may provide a secure, customized mount. In such a manner, for example, the scope mount 140 may, once it has been fitted mating the grooves, be removed by disengagement of the first thumb screw 150a and reattached or mounted by reengagement of the first thumb screw 150a (and alignment of the glass-bedded grooves), while maintaining the “zero” of the firearm 110.

In some embodiments, any or all of the components 110, 112, 114, 120, 122, 124, 126a-b, 128, 130, 132, 134, 136, 140, 142, 142-3, 142-6, 148b, 150a-b of the firearm sighting system 100 may be similar in configuration and/or functionality to any similarly named and/or numbered components described herein. Fewer or more components 110, 112, 114, 120, 122, 124, 126a-b, 128, 130, 132, 134, 136, 140, 142, 142-3, 142-6, 148b, 150a-b (and/or portions thereof) and/or various configurations of the components 110, 112, 114, 120, 122, 124, 126a-b, 128, 130, 132, 134, 136, 140, 142, 142-3, 142-6, 148b, 150a-b may be included in the firearm sighting system 100 without deviating from the scope of embodiments described herein. In some embodiments, one or more of the various components 110, 112, 114, 120, 122, 124, 126a-b, 128, 130, 132, 134, 136, 140, 142, 142-3, 142-6, 148b, 150a-b may not be needed and/or desired in the firearm sighting system 100.

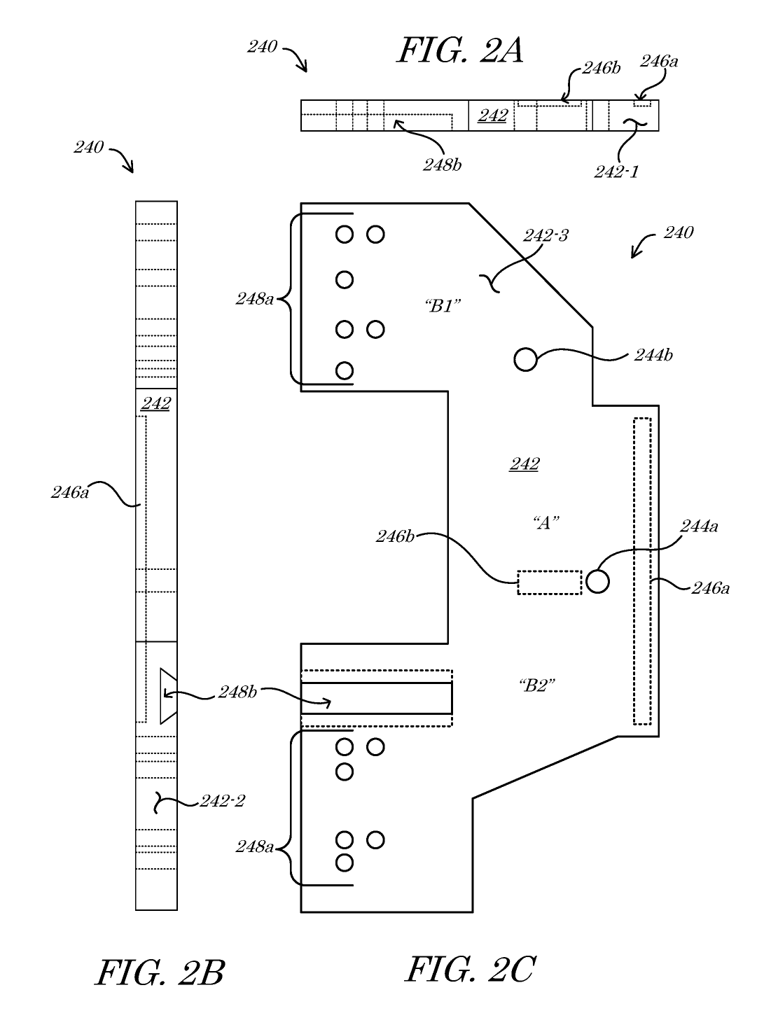

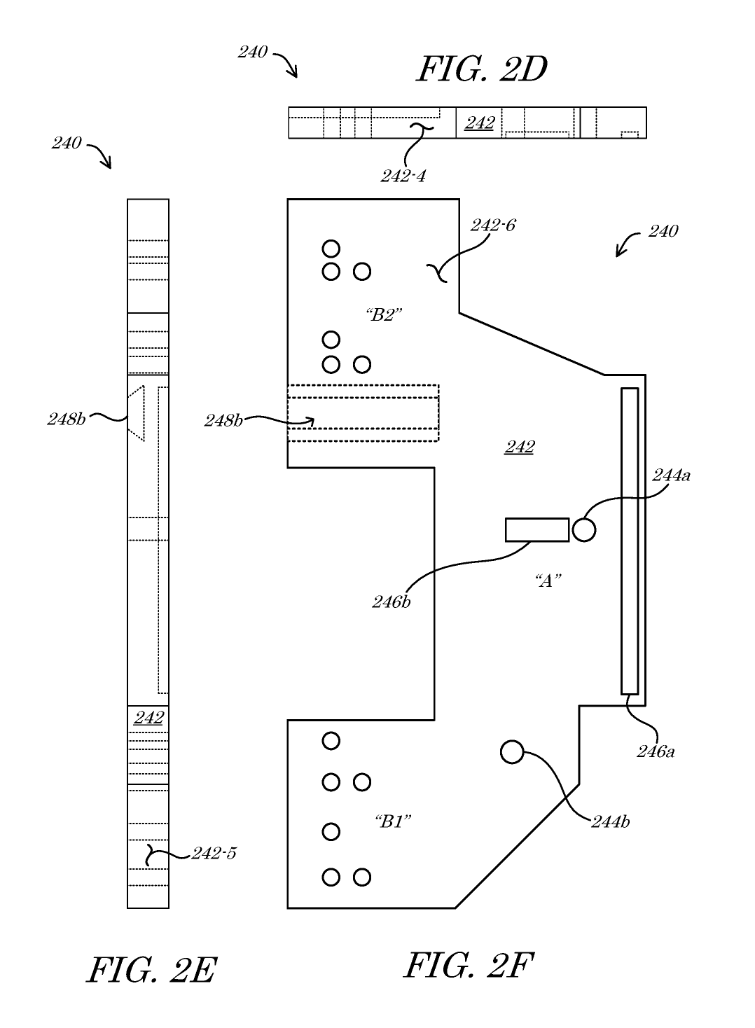

Turning to FIG. 2A, FIG. 2B, FIG. 2C, FIG. 2D, FIG. 2E, and FIG. 2F, front, top, left-side, rear, bottom, and right-side views of a sight mount 240 according to some embodiments are shown. In some embodiments, the sight mount 240 may comprise a shaped body element 242 comprising and/or defining a first side or front surface 242-1, a second side or top surface 242-2, a third side or left-side surface 242-3, a fourth side or rear surface 242-4, a fifth side or bottom surface 242-5, and/or a sixth side or right-side surface 242-6. According to some embodiments, the shaped body element 242 may be constructed of steel, steel alloy, stainless steel, carbon-fiber, and/or other rigid and durable materials that are or become known or practicable. In some embodiments, the shaped body element 242 may comprise one or more threaded holes 244a-b (in some embodiments, the threaded holes 244a-b may not be threaded, but may instead be operable to receive threaded fasteners that past through such holes 244a-b). A first one of the threaded holes 244a may be disposed or positioned, in some embodiments, on a central portion “A” of the shaped body element 242 proximate to the bottom surface 242-5 (e.g., at a first distance from the bottom surface 242-5). According to some embodiments, a second one of the threaded holes 244b may be disposed or positioned at a base of a first arm portion “B1” of the shaped body element 242 at a second distance from the bottom surface 242-5. In some embodiments, the second distance from the bottom surface 242-5 may be greater than the first distance from the bottom surface 242-5, e.g., as depicted in FIG. 2C. In some embodiments, the threaded holes 244a-b may be utilized to accept and/or removably couple to respective fasteners (not shown; e.g., the thumb screws 150a-b of FIG. 1 herein) that align and mate with one or more mounting holes on a firearm receiver (not shown).

According to some embodiments, the shaped body element 242 may comprise one or more mounting slits, channels, or grooves 246a-b. As depicted in FIG. 2F, for example, a first mounting groove 246a may extend longitudinally along the shaped body element 242 on the right-side surface 242-6 and adjacent to the bottom surface 242-5. In some embodiments, a second mounting groove 246b may extend laterally (and/or perpendicular to the first mounting groove 246a) from a first location on the right-side surface 242-6 adjacent to the first one of the threaded holes 244a and extend away from the first one of the threaded holes 244a to a second location on the right-side surface 242-6. According to some embodiments, the mounting grooves 246a-b may be utilized to provide enhanced mounting characteristics with a firearm receiver (not shown; e.g., the receiver 112 of FIG. 1). The mounting grooves 246a-b may, for example, be located and/or sized to pair with one or more grooves on a firearm receiver such that a mating of the sight mount 240 to the receiver forms a void (not shown) between the paired receiver grooves and the respective mounting grooves 246a-b of the sight mount 240. In some embodiments, the void may be filled with a glass-bedding substance such as epoxy and/or other adhesive and/or setting compounds (and/or a malleable metal and/or substance) and allowed to cure or set. In such a manner, for example, the sight mount 240 and the receiver of the firearm may be precisely aligned and securely mated. According to some embodiments, the epoxy (and/or other binding and/or setting substance) may be utilized to secure a metal strip and/or rod (not shown) between the corresponding grooves (i.e., in the void). A metal hexagonal rod may be fitted in the void with a setting compound such as epoxy, for example, and be allowed to be cured between the receiver and the mounting grooves 246a-b, providing for a precise fit with high-strength characteristics.

In some embodiments, the sight mount 240 and/or the shaped body element 242 may comprise various secondary sight mounting elements 248a-b such as a plurality of rail base mounting holes 248a and/or a dovetail groove 248b. The plurality of rail base mounting holes 248a may, for example, comprise various aligned holes arranged on each of first arm portion “B1” of the shaped body element 242 and a second arm portion “B2” of the shaped body element 242. As depicted in FIG. 2C and FIG. 2F, the plurality of rail base mounting holes 248a may be arranged in two separate patterns, one on each arm portion “B1”, “B2”, such that the two patterns are separated longitudinally along the sight mount 240 by a distance appropriate for mounting longer secondary sights such as telescopic sights (not shown; e.g., the first sighting device 120 of FIG. 1 herein). According to some embodiments, the rail base mounting holes 248a may permit mounting of various types of rail bases (not shown; e.g., the scope rail 128 of FIG. 1) on the left-side surface 242-3 and/or the right-side surface 242-6 of the shaped body element 242. In such a manner, multiple secondary sights may be mounted to a firearm, e.g., while maintaining the usability of the fixed sights thereof. In some embodiments, the sight mount 240 and/or the shaped body element 242 may comprise one or more scope bases and/or rails (not shown) instead of or in addition to the rail base mounting holes 248a. In some embodiments, the sight mount 240 and/or the shaped body element 242 may comprise the dovetail groove 248b for mounting of various types of sights, scopes, and/or accessories. The dovetail groove 248b may, for example, comprise a trapezoidal channel formed and/or cut into the left-side surface 242-3 and extending from the top surface 242-2 to a point near the base of the second arm portion “B2” of the shaped body element 242. In some embodiments, fewer or more rail base mounting holes 248a and/or dovetail grooves 248b may be utilized as desired to mount various arrays of sights, scopes, and/or accessories.

According to some embodiments, any or all of the components 242, 242-1, 242-2, 242-3, 242-4, 242-5, 242-6, 244a-b, 246a-b, 248a-b of the sight mount 240 may be similar in configuration and/or functionality to any similarly named and/or numbered components described herein. Fewer or more components 242, 242-1, 242-2, 242-3, 242-4, 242-5, 242-6, 244a-b, 246a-b, 248a-b (and/or portions thereof) and/or various configurations of the components 242, 242-1, 242-2, 242-3, 242-4, 242-5, 242-6, 244a-b, 246a-b, 248a-b may be included in the sight mount 240 without deviating from the scope of embodiments described herein. In some embodiments, one or more of the various components 242, 242-1, 242-2, 242-3, 242-4, 242-5, 242-6, 244a-b, 246a-b, 248a-b may not be needed and/or desired in the sight mount 240.

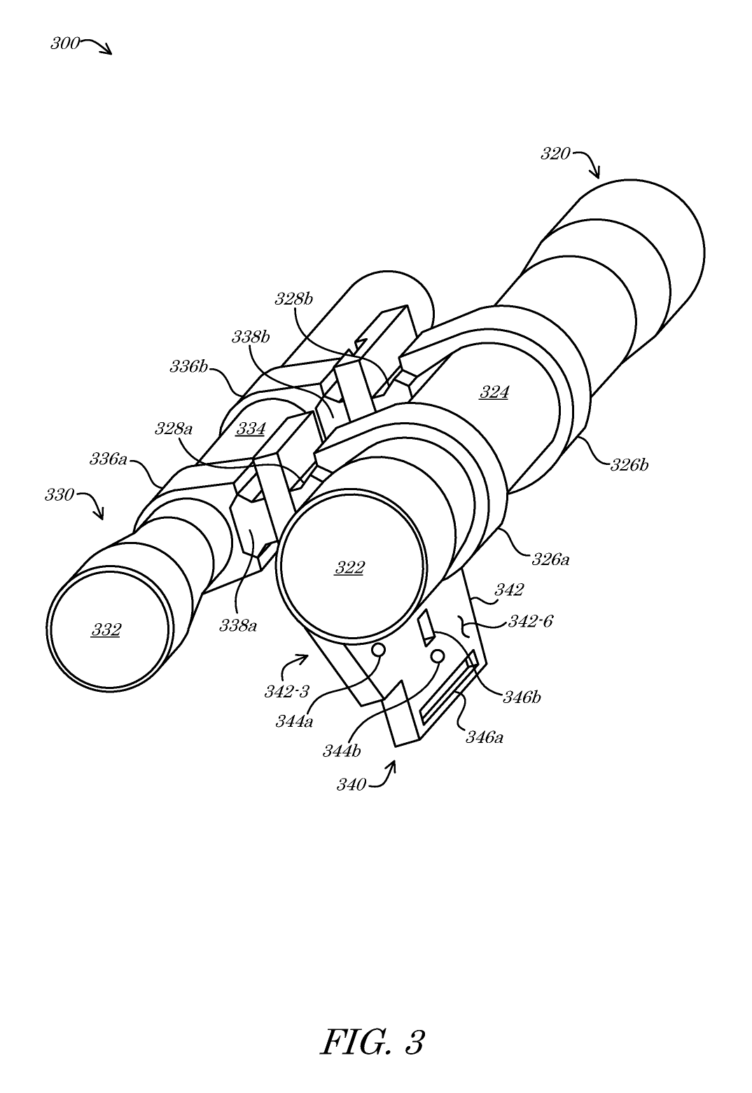

Referring now to FIG. 3, a front-right perspective view of a firearm sighting system 300 according to some embodiments is shown. The firearm sighting system 300 may comprise, for example, an optical sighting array tailored to long-range shooting by employing multiple optical elements of different fixed (or variable) magnification powers. In some embodiments, the firearm sighting system 300 may comprise a first scope 320 having first optics 322 of a first magnification power such as ten times (10×) housed in a generally cylindrical first scope body 324. According to some embodiments, the first scope body 324 may be retained and/or coupled to one or more first scope rings 326a-b that are respectively mounted and/or coupled to one or more first scope bases or rails 328a-b. In some embodiments, the firearm sighting system 300 may comprise a second scope 330 having second optics 332 of a second magnification power such as five times (5×) housed in a generally cylindrical second scope body 334. According to some embodiments, the second scope body 334 may be retained and/or coupled to one or more second scope rings 336a-b that are respectively mounted and/or coupled to one or more second scope bases or rails 338a-b.

According to some embodiments, each of the scope rails 328a-b, 338a-b may be mounted and/or coupled to (and/or formed on or be integral to) a sight mount 340. The sight mount 340 may comprise, for example, a vertical mount body 342 having a left-side surface 342-3 and a right-side surface 342-6. In some embodiments, the right-side surface 342-6 of the mount body 342 and/or the sight mount 340 may be configured to mate with a side surface of a firearm receiver (not shown). The right-side surface 342-6 may comprise, for example, one or more mounting holes 344a-b and/or one or more indents, channels, seats, and/or grooves 346a-b. According to some embodiments, the one or more mounting holes 344a-b may be positioned and/or sized to align with one or more holes (not shown) on a specific type of firearm (or other ranged device) such as arranged for an M14/M1A rifle variant as depicted in FIG. 3. The mount body 342 may comprise a first one of the mounting holes 344a disposed longitudinally (e.g., as measured in the sight direction of the scopes 320, 330) centrally on the mount body 342 and near the bottom of the mount body 342. In some embodiments, a second one of the mounting holes 344b may be disposed longitudinally offset to the left or front of the mount body 342 with respect to the first one of the mounting holes 344a, and may be disposed further from the bottom of mount body 342 than the first one of the mounting holes 344a.

In some embodiments, a first one of the grooves 346a may be disposed, cut, and/or formed into the right-side surface 342-6 of the mount body 342 at a position near the bottom of the mount body 342 and/or may run longitudinally along the mount body 342, e.g., beneath the first one of the mounting holes 344a. According to some embodiments, a second one of the grooves 346b may be disposed, cut, and/or formed into the right-side surface 342-6 of the mount body 342 at a position above the first one of the mounting holes 344a and/or may run laterally upwards away from the first one of the mounting holes 344a. In such a manner, for example, the first one of the mounting holes 344a may align with a threaded hole (not shown) in the side of an M14/M1A style receiver and one or more of the grooves 346a-b may align with corresponding grooves on the side of the receiver. The corresponding grooves 346a-b of the sight mount 340 and the receiver may then be fitted with a metal rod, malleable metal substance, and/or epoxy/resin or other bonding/setting agent (none of which are shown) and pressed together to customize the fit of the sight mount 340 to the receiver. Such a customized fit may permit, as described herein, the sight mount 340 to be repeatedly removed and reinstalled on the receiver while retaining proper alignment of the sight mount 340 and the receiver, preventing the firearm from deviating from a set “zero”.

In some embodiments, any or all of the components 320, 322, 324, 326a-b, 328a-b, 330, 332, 334, 336a-b, 338a-b, 340, 342, 342-3, 342-6, 344a-b, 346a-b, 348b of the firearm sighting system 300 may be similar in configuration and/or functionality to any similarly named and/or numbered components described herein. Fewer or more components 320, 322, 324, 326a-b, 328a-b, 330, 332, 334, 336a-b, 338a-b, 340, 342, 342-3, 342-6, 344a-b, 346a-b, 348b (and/or portions thereof) and/or various configurations of the components 320, 322, 324, 326a-b, 328a-b, 330, 332, 334, 336a-b, 338a-b, 340, 342, 342-3, 342-6, 344a-b, 346a-b, 348b may be included in the firearm sighting system 300 without deviating from the scope of embodiments described herein. In some embodiments, one or more of the various components 320, 322, 324, 326a-b, 328a-b, 330, 332, 334, 336a-b, 338a-b, 340, 342, 342-3, 342-6, 344a-b, 346a-b, 348b may not be needed and/or desired in the firearm sighting system 300.

The sight and/or scope mount embodiments described herein generally provide a simple yet novel sight mounting paradigm that allows users to utilize a plurality of optical sights and/or accessories without disadvantages of previous systems and while maintaining access to any fixed sights. Such an improved sighting system may generally permit a shooter (or other user) to arrange an optical array of multiple sights that are customized for any one of various different sighting situations. First, for example, each of a short-range optical sight (e.g., a reflex sight) and mid-range optical sight may be utilized for rapid target acquisition (via the short-range sight) and more accurate target engagement (via the mid-range sight). As described herein and as is now possible utilizing the sight mount as described herein, the user may simply switch eyes to utilize the different sights, as the sights may be mounted laterally and aligned on the same optical plane with respect to the firearm (or other ranged device). This prevents, for example, the need to reposition the firearm to utilize the different sights, which increases time on-target. Second, for example, each of a mid-range optical sight and a long-range optical sight may be utilized for more rapid target acquisition (via the mid-range sight having a wider field of view) and more accurate target engagement (via the long-range sight). Such a sighting method is quicker and easier than the current method of utilizing a separate spotting scope or changing the zoom setting of a single variable-powered telescopic sight—each of which may cause repositioning and accordingly lost time on-target.

Several example scope and sight setups coupled to the sight mount described herein are depicted and described for purposes of non-limiting explanation. Other setups of various sights, scopes, lights, lasers, imaging devices, and/or other accessories may be utilized as is or becomes desirable or practicable. While an example of a reflex sight being mounted in a position for a shooter's left eye and a telescopic sight being mounted in a position for the shooter's right eye (e.g., in the same plane) is provided, for example, the reflex sight may instead be positioned for the shooter's right eye, the telescopic sight may be replaced with a different reflex site such that two (2) reflex sites are utilized simultaneously, one of the sights may be replaced with an illumination device (e.g., a flashlight or IR illuminator), etc.

Some embodiments herein may be associated with the term “approximately”. As utilized herein, the term approximately generally refers to either a specifically-recited numerical value or a range of values that fall between plus or minus ten percent (10%) of the recited value. In the case that a particular value is recited without the qualifier of “approximately”, it should be understood that, unless specifically limited, equivalents to such value are also contemplated and generally fall between plus or minus five percent (5%) of the recited value. Although specific quantities, values, and/or measurements are presented herein for purposes of example and ease of explanation, such quantities, values, and/or measurements are not limiting and equivalent, approximate, and/or different quantities, values, and/or measurements may be utilized without deviating from the scope of some embodiments.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant currently intends to file additional applications to pursue patents for subject matter that has been disclosed and enabled but not claimed in the present application.

What is claimed is:

1. A sight mount, comprising:
a planar body element defining first and second side surfaces and top and bottom edges, wherein each of the first and second side surfaces comprises a sight mounting feature proximate to the top edge of the planar body element, wherein the planar body element comprises at least one mounting hole extending through the planar body element from the first side surface to the second side surface, and wherein the first side surface comprises at least one channel disposed proximate to the bottom edge of the planar body element.

2. The sight mount of claim 1, wherein at least one of the sight mounting features comprises a dovetail channel extending into the planar body element from the top edge of the planar body element.

3. The sight mount of claim 2, wherein the dovetail channel is disposed on the first side surface of the planar body element.

4. The sight mount of claim 2, wherein the dovetail channel is disposed on the second side surface of the planar body element.

5. The sight mount of claim 1, wherein at least one of the sight mounting features comprises a rail base.

6. The sight mount of claim 5, wherein the rail base is disposed on the first side surface of the planar body element.

7. The sight mount of claim 5, wherein the rail base is disposed on the second side surface of the planar body element.

8. The sight mount of claim 1, wherein the at least one mounting hole is centered over the at least one channel on the first side surface.

9. A dual-sight mount system, comprising:
a firearm comprising a receiver defining a top and sides;
a fixed sight coupled to the top of the receiver;
a threaded mounting hole disposed on a first side of the receiver;
a groove disposed on the first side of the receiver;
a first optical sight;
a first optical sight mounting base coupled to the first optical sight;
a second optical sight;
a second optical sight mounting base coupled to the second optical sight;
a sight mount defining a first side surface and a second side surface, the sight mount comprising a mounting hole aligned with the threaded mounting hole of the first side of the receiver and a groove aligned with the groove of the first side of the receiver, wherein an alignment of the groove of the sight mount and the groove of the first side of the receiver defines a void between the sight mount and the receiver, and wherein each of the first optical sight mounting base and the second optical sight mounting base are coupled to the sight mount along a sight plane perpendicular to the top of the receiver;
a threaded fastener engaged through the mounting hole of the sight mount and engaged with the threaded mounting hole of the first side of the receiver; and
a setting material disposed within the void between the sight mount and the receiver.

10. The dual-sight mount system of claim 9, wherein the first optical sight mounting base is coupled to the first side surface of the sight mount and the second optical sight mounting base is coupled to the second side surface of the sight mount.

11. The dual-sight mount system of claim 10, wherein the groove of the sight mount is disposed on the first side surface of the sight mount.

12. The dual-sight mount system of claim 9, wherein the first optical sight comprises a telescopic sight and the second optical sight comprises a reflex sight.
